(19) United States
(12) Patent Application Publication
(10) Pub. No.: US 2021/0182405 A1
(43) Pub. Date: Jun. 17, 2021

(54) SECURITY ASSESSMENT DEVICE, SECURITY ASSESSMENT METHOD, AND COMPUTER READABLE MEDIUM

(71) Applicant: Mitsubishi Electric Corporation, Tokyo (JP)

(72) Inventors: Takumi YAMAMOTO, Tokyo (JP); Hiroki NISHIKAWA, Tokyo (JP); Kiyoto KAWAUCHI, Tokyo (JP)

(73) Assignee: Mitsubishi Electric Corporation, Tokyo (JP)

(21) Appl. No.: 17/167,832

(22) Filed: Feb. 4, 2021

Related U.S. Application Data
(63) Continuation of application No. PCT/JP2018/036379, filed on Sep. 28, 2018.

(51) Int. Cl. G06F 21/57

(52) U.S. Cl. CPC G06F 21/577; G06F 2221/034

(57) ABSTRACT

A disclosed feature generation unit (110) collects information related to an assessment target whose security risk is to be assessed, as disclosure target information from disclosed information that has been disclosed, and generates disclosed feature information (F1) expressing a feature of the disclosure target information. An email feature generation unit (120) generates email feature information F2 expressing a feature of an assessment target email contained in an email box of the assessment target. An assessment unit (130) calculates a similarity degree between the disclosed feature information (F1) and the email feature information (F2). The assessment unit (130) outputs an assessment result 31 being a result of assessment on the security risk of the assessment target, based on the similarity degree.

### CROSS REFERENCE TO RELATED APPLICATION

This application is a Continuation of PCT International Application No. PCT/JP2018/036379, filed on Sep. 28, 2018, which is hereby expressly incorporated by reference into the present application.

### TECHNICAL FIELD

The present invention relates to a security assessment device, a security assessment method, and a security assessment program. Particularly, the present invention relates to a security assessment device, a security assessment method, and a security assessment program that assess a personal security risk.

### BACKGROUND ART

In recent years, damage caused by targeted attacks has increased. Most targeted attacks originate from emails from attackers. An attacker carefully examines information on a target organization or its staff and prepares a high-quality attack email tailored to the target. Here, a “high-quality attack email” can be defined as an “illegitimate email indistinguishable from a legitimate email authentic to the target”. In other words, if it is possible to generate an email very similar to a legitimate email which the target receives, it is possible to say that the attacker has prepared a “high-quality attack email”.

Also, recently, information about individuals has been disclosed everywhere on the Internet, including social networks. An attacker generates a “high-quality attack email” tailored to a target by collecting information disclosed on the Internet using a name of a target organization or a name of a person as a keyword. Therefore, to determine susceptibility of an individual to an attack caused by “a high-quality attack mail” is effective in carrying out security measures.

In Non-Patent Literature 1, a relationship between psychological characteristics and behavioral characteristics of a user when using a Personal Computer (PC) is clarified. Then, ordinary behavioral characteristics when using the PC are monitored, and a user in a psychological state of being easily damaged is determined.

### CITATION LIST

### Patent Literature

Non-Patent Literature 1: KATAYAMA Yoshinori, TERADA Takeaki, TORII Satoru, TSUDA Hiroshi, “An Attempt to Visualization of Psychological and Behavioral Characteristics of Users Vulnerable to Cyber Attack”, SCIS2015 Symposium on Cryptography and Information Security, 4D1-3

### SUMMARY OF INVENTION

### Technical Problem

Non-Patent Literature 1 has a problem that since it uses a psychological state which is information difficult to quantify, it is difficult to make an evidenced interpretation of an obtained causal relationship.

An objective of the present invention is to quantitatively and automatically assess an individual's security risk, that is, susceptibility to a targeted attack email, and to identify a person having a high security risk, at an early stage.

### Solution to Problem

A security assessment device according to the present invention includes:

a disclosed feature generation unit to collect information related to an assessment target whose security risk is to be assessed, as disclosure target information from disclosed information that has been disclosed, and to generate disclosed feature information expressing a feature of the disclosure target information;

an email feature generation unit to generate email feature information expressing a feature of an assessment target email contained in an email box of the assessment target; and

an assessment unit to calculate a similarity degree between the disclosed feature information and the email feature information and to output an assessment result being a result of assessment on the security risk of the assessment target, based on the similarity degree.

### Advantageous Effects of Invention

With a security assessment device according to the present invention, a security risk of an assessment target is assessed based on a similarity degree between a feature of an assessment target email contained in an email box of the assessment target and a feature of information related to the assessment target and obtained from disclosed information. Therefore, with the security assessment device according to the present invention, susceptibility to a targeted attack email can be assessed quantitatively and automatically.

### BRIEF DESCRIPTION OF DRAWINGS

FIG. 1 is a configuration diagram of a security assessment device according to Embodiment 1.

FIG. 2 is a flowchart of operations of the security assessment device according to Embodiment 1.

FIG. 3 is a configuration diagram of a security assessment device according to a modification of Embodiment 1.

FIG. 4 is a configuration diagram of a security assessment device according to Embodiment 2.

FIG. 5 is a diagram illustrating an example of a template according to Embodiment 2.

FIG. 6 is a flowchart of operations of the security assessment device according to Embodiment 2.

FIG. 7 is a diagram illustrating an example of disclosure target information according to Embodiment 2, which is classified according to categories.

FIG. 8 is a diagram illustrating examples of template emails according to Embodiment 2.

FIG. 9 is a configuration diagram of a security assessment device according to Embodiment 3.

FIG. 10 is a flowchart of operations of a vulnerability identification unit according to Embodiment 3.

### DESCRIPTION OF EMBODIMENTS

Embodiments of the present invention will be described below with referring to drawings. In the drawings, the same or equivalent portion is denoted by the same reference sign. In description of the embodiments, explanation on the same or equivalent portion will be appropriately omitted or simplified.

### Embodiment 1

***Description of Configurations***

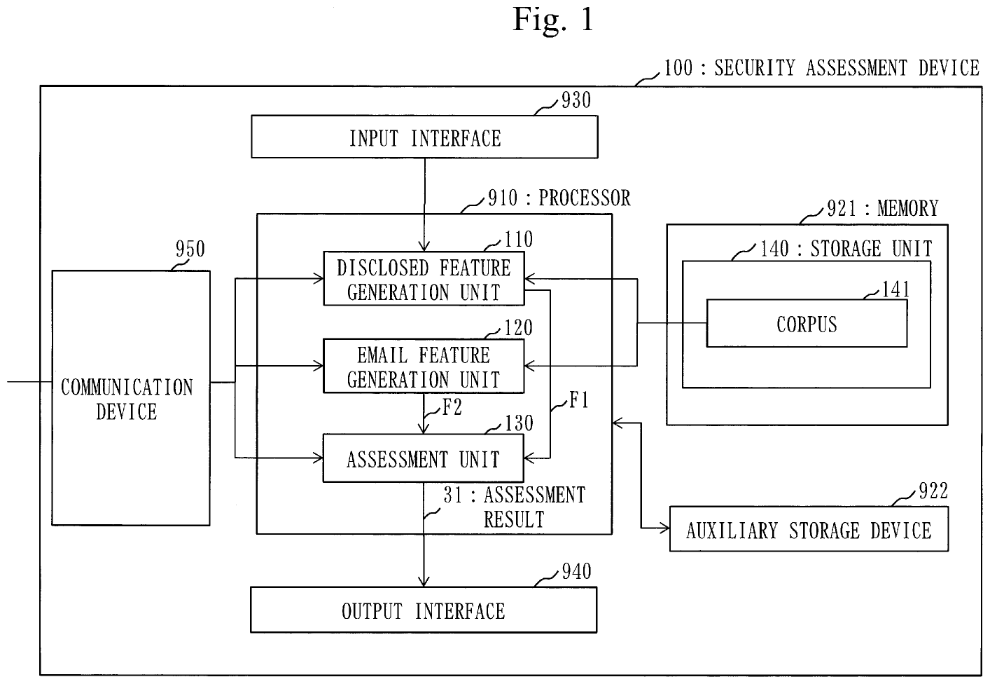

A configuration of a security assessment device 100 according to the present embodiment will be described with referring to FIG. 1.

The security assessment device 100 is a device that assesses a security risk of an assessment target such as a person and an organization. In the present embodiment, the assessment target will be an individual. However, the assessment target may be any other target such as an organization and a region as far as its security risk is assessable.

The security assessment device 100 is a computer. The security assessment device 100 is provided with a processor 910 and is also provided with other hardware devices such as a memory 921, an auxiliary storage device 922, an input interface 930, an output interface 940, and a communication device 950. The processor 910 is connected to the other hardware devices via signal lines and controls these other hardware devices.

The security assessment device 100 is provided with a disclosed feature generation unit 110, an email feature generation unit 120, an assessment unit 130, and a storage unit 140, as function elements. A corpus 141 is stored in the storage unit 140.

Functions of the disclosed feature generation unit 110, email feature generation unit 120, and assessment unit 130 are implemented by software. The storage unit 140 is provided to the memory 921.

The processor 910 is a device that implements a security assessment program. The security assessment program is a program that implements the functions of the disclosed feature generation unit 110, email feature generation unit 120, and assessment unit 130.

The processor 910 is an Integrated Circuit (IC) which performs computation processing. Specific examples of the processor 910 include a CPU, a Digital Signal Processor (DSP), and a Graphics Processing Unit (GPU).

The memory 921 is a storage device that stores data temporarily. Specific examples of the memory 921 include a Static Random Access Memory (SRAM) and a Dynamic Random Access Memory (DRAM).

The auxiliary storage device 922 is a storage device that stores data. Specific examples of the auxiliary storage device 922 include an HDD. The auxiliary storage device 922 may be a storage medium such as an SD (registered trademark) memory card, a CF, a NAND flash, a flexible disk, an optical disk, a compact disk, a blu-ray (registered trademark) disk, and a DVD. Note that HDD stands for Hard Disk Drive, SD (registered trademark) for Secure Digital, CF for CompactFlash (registered trademark), and DVD for Digital Versatile Disk.

The input interface 930 is a port connected to an input device such as a mouse, a keyboard, and a touch panel. The input interface 930 is specifically a Universal Serial Bus (USB) terminal. The input interface 930 may be a port connected to a Local Area Network (LAN).

The output interface 940 is a port to which a cable of an output apparatus such as a display is connected. The output interface 940 is specifically a USB terminal or a High Definition Multimedia Interface (HDMI: registered trademark) terminal. The display is specifically a Liquid Crystal Display (LCD).

The communication device 950 has a receiver and a transmitter. The communication device 950 is connected to a communication network such as a LAN, the Internet, and a telephone line. The communication device 950 is specifically a communication chip or a Network Interface Card (NIC).

The security assessment program is read by the processor 910 and executed by the processor 910. Not only the security assessment program but also an Operating System (OS) is stored in the memory 921. The processor 910 executes the security assessment program while executing the OS. The security assessment program and the OS may be stored in the auxiliary storage device. The security assessment program and the OS which are stored in the auxiliary storage device are loaded to the memory 921 and executed by the processor 910. The security assessment program may be incorporated in the OS partly or entirely.

The security assessment device 100 may be provided with a plurality of processors that substitute for the processor 910. The plurality of processors share execution of the security assessment program. Each processor is a device that executes the security assessment program just as the processor 910 does.

Data, information, signal values, and variable values that are utilized, processed, or outputted by the security assessment program are stored in the memory 921, the auxiliary storage device 922, or a register or cache memory in the processor 910.

The word “unit” appearing in each name of the disclosed feature generation unit 110, the email feature generation unit 120, and the assessment unit 130 may be replaced by “process”, “procedure”, or “stage”. The word “process” appearing in each name of a disclosed feature generation process, an email feature generation process, and an assessment process may be replaced by “program”, “program product”, “computer readable storage medium recorded with a program”, or “computer readable recording medium recorded with a program”.

The security assessment program causes the computer to execute each process, each procedure, or each stage that corresponds to the individual unit described above with its “unit” being replaced by “process”, “procedure”, or “stage”. The security assessment method is a method that is carried out as the security assessment device 100 executes the security assessment program.

The security assessment program may be stored in a computer readable recording medium and provided in the form of the recording medium. Alternatively, the security assessment program may be provided as a program product.

***Description of Operations***

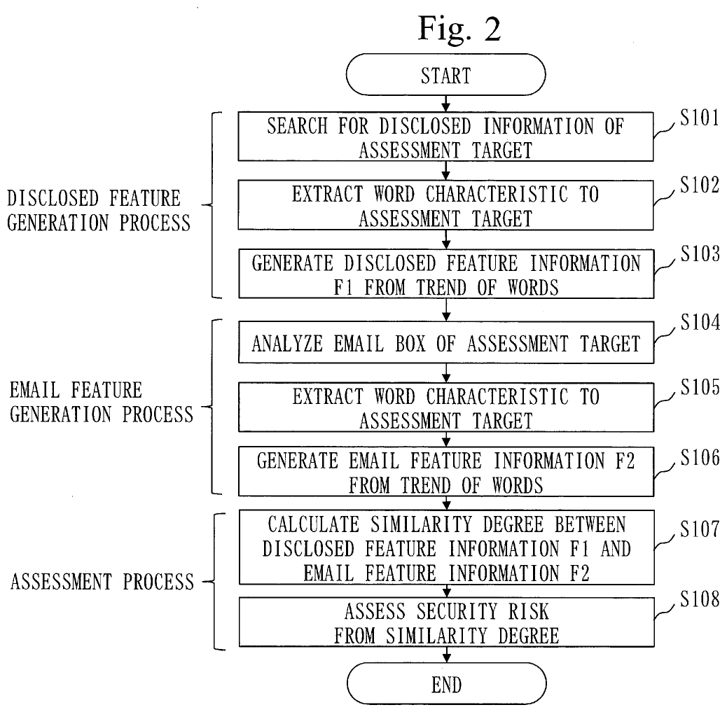

Operations of the security assessment device 100 according to the present embodiment will be described with referring to FIG. 2.

<Disclosed Feature Generation Process: Step S101 to Step S103>

In a disclosed feature generation process, the disclosed feature generation unit 110 collects information related to an assessment target whose security risk is to be assessed, as disclosure target information from disclosed information that has been disclosed. Then, the disclosed feature generation unit 110 generates disclosed feature information F1 expressing a feature of the disclosure target information. Specifically, this is as follows.

In step S101, the disclosed feature generation unit 110 searches for information related to a person x whose security risk is to be assessed, from the disclosed information. An act of collecting information from disclosed information that is disclosed on the Internet including social networks is called Open Source Intelligence (OSINT). The disclosed feature generation unit 110 searches for the information related to the person x from the disclosed information, using OSINT. Specifically, the disclosed feature generation unit 110 collects the disclosed information related to the person x being an assessment target, utilizing an existing tool dedicated to OSINT or a search engine. Specific examples of the existing tool dedicated to OSINT include tools such as Maltego and Online Internet Search Tool.

In step S102, the disclosed feature generation unit 110 collects a word related to the assessment target, as disclosure target information from the disclosed information. Specifically, first, the disclosed feature generation unit 110 extracts a keyword characteristic to the person x, from the disclosed information. At this time, the disclosed feature generation unit 110 excludes a word that might be often utilized in a general document, from the disclosed information related to the person x. That is, the disclosed feature generation unit 110 extracts a word with a high TF-IDF value. By extracting a word with a high TF-IDF value in this manner, only a word appearing not often in a general document and having a high significance can be obtained. Note that TF-IDF stands for Term Frequency-Inverse Document Frequency. TF-IDF is one of schemes of assessing a significance of a word contained in a document. As the schemes of extracting significant information from a document, Doc2Vec and Latent Dirichlet Allocation (LDA) are available other than TF-IDF. Also, the disclosed feature generation unit 110 extracts only a word belonging to a particular part of speech, for example, a noun. At this time, the disclosed feature generation unit 110 extracts the word using the corpus 141 containing information such as a general word and a part of speech. The disclosed feature generation unit 110 extracts only a word belonging to a particular part of speech, utilizing a morphological analysis technique such as Mecab. As described above, the disclosed feature generation unit 110 acquires a list of words belonging to a particular part of speech that has a high significance, as disclosure target information W1.

In step S103, the disclosed feature generation unit 110 generates disclosed feature information F1 expressing a feature of the disclosure target information W1, based on a trend of words contained in the disclosure target information W1. Specifically, the disclosed feature generation unit 110 extracts a trend of words in the disclosure target information W1 which is a list of words. The trend is a word frequency, or word co-occurrence such as n-gram. The disclosed feature generation unit 110 generates the disclosed feature information F1 by converting such trend of words into a feature vector.

<Email Feature Generation Process: Step S104 to Step S106>

In an email feature generation process, the email feature generation unit 120 generates email feature information expressing a feature of an assessment target email contained in a mail box of the assessment target. Specifically, this is as follows.

In step S104, the email feature generation unit 120 analyzes the email box of the person x being the assessment target.

In step S105, the email feature generation unit 120 collects a word related to the assessment target, as email word information from the assessment target email contained in the email box of the assessment target. The email feature generation unit 120 extracts assessment target emails one by one from the email box of an email system of the person x, and extracts words. The email feature generation unit 120 excludes a word that might be often utilized in a general document, just as the disclosed feature generation unit 110 does. The email feature generation unit 120 also extracts only a word belonging to a particular part of speech, for example, a noun, just as the disclosed feature generation unit 110 does. At this time, the email feature generation unit 120 extracts the word using the corpus 141 containing a general word and information such as a part of speech. As described above, the email feature generation unit 120 acquires a list of words having a high significance and belonging to a particular part of speech, as email word information W2.

In step S106, the email feature generation unit 120 generates email feature information F2 expressing a feature of the assessment target email, based on a trend of words contained in the email word information W2. Specifically, the email feature generation unit 120 extracts a trend of words in the email word information W2 which is a list of words. A trend is a word frequency, or word co-occurrence such as n-gram. The email feature generation unit 120 generates the email feature information F2 by converting such trend of words into a feature vector.

<Assessment Process: Step S107 to Step S108>

In an assessment process, the assessment unit 130 calculates a similarity degree between the disclosed feature information F1 and the email feature information F2. The assessment unit 130 outputs an assessment result 31 being a result of assessment on the security risk of the assessment target based on the similarity degree. Specifically, this is as follows.

In step S107, the assessment unit 130 finds the similarity degree between the disclosed feature information F1 and the email feature information F2. Specifically, the assessment unit 130 finds the similarity degree between the disclosed feature information F1 and the email feature information F2 utilizing a criterion such as a cosine similarity degree and the Euclidian distance between feature vectors.

In step S108, the assessment unit 130 judges whether or not there is a security risk about the assessment target based on the similarity degree, and outputs a judgment result as the assessment result 31. Specifically, if the similarity degree is equal to or more than a threshold, the assessment unit 130 judges that the person x has a high security risk, that is, there is a security risk, and outputs an assessment result 31 that there is a security risk about the person x. If the similarity degree is smaller than the threshold, the assessment unit 130 judges that the person x has a low security risk, that is, there is no security risk, and outputs an assessment result 31 that there is no security risk about the person x.

A security assessment process according to the present embodiment judges how accurately information similar to the trend of words in the legitimate email of the person x can be obtained from the disclosed information. In other words, the security assessment process according to the present embodiment judges how indistinguishable by the person x from a legitimate email, an illegitimate email, that is, a targeted attack email, generated by an attacker with using OSINT can be.

***Other Configurations***

<Modification 1>

In the present embodiment, the email feature generation unit 120 generates the email feature information F2 from the entire emails in the email box of the assessment target person x. Alternatively, the email feature generation unit 120 may generate email feature information per email, instead of from the entire emails in the email box. In this case, if emails whose similarity degrees are equal to or more than the threshold are contained in a certain number or more in the whole email box, the email feature generation unit 120 judges that there is a security risk about the assessment target person x.

<Modification 2>

In the present embodiment, the functions of the disclosed feature generation unit 110, email feature generation unit 120, and assessment unit 130 are implemented by software. In a modification, the functions of the disclosed feature generation unit 110, email feature generation unit 120, and assessment unit 130 may be implemented by hardware.

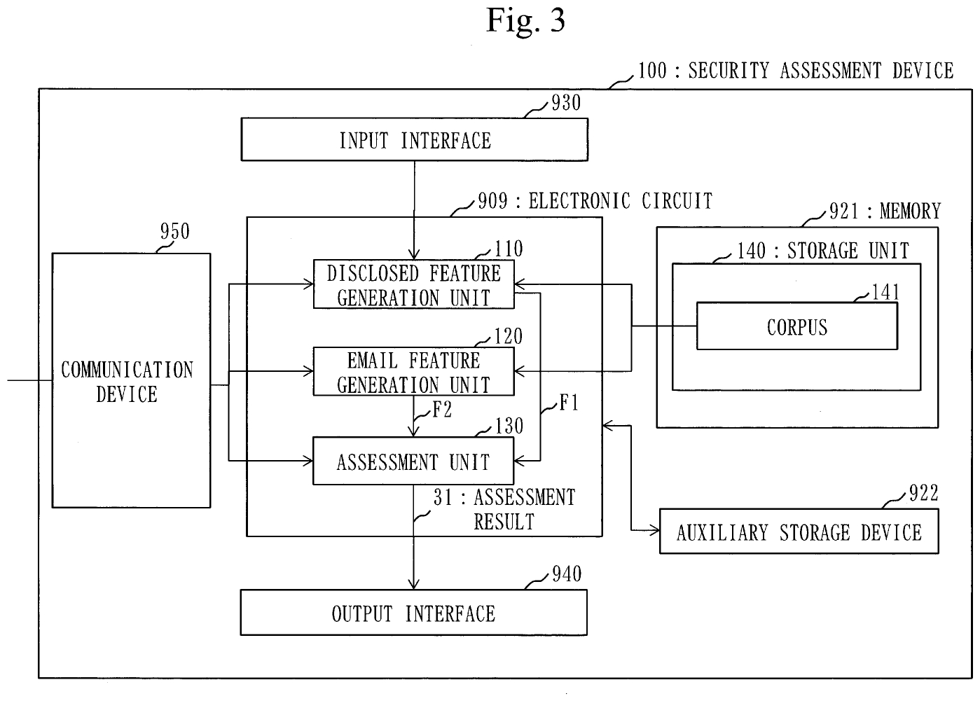

FIG. 3 is a diagram illustrating a configuration of a security assessment device 100 according to a modification of the present embodiment.

The security assessment device 100 is provided with an electronic circuit 909, a memory 921, an auxiliary storage device 922, an input interface 930, an output interface 940, and a communication device 950.

The electronic circuit 909 is a dedicated electronic circuit that implements functions of a disclosed feature generation unit 110, email feature generation unit 120, and assessment unit 130.

The electronic circuit 909 is specifically a single circuit, a composite circuit, a programmed processor, a parallel-programmed processor, a logic IC, a GA, an ASIC, or an FPGA. Note that GA stands for Gate Array, ASIC for Application Specific Integrated Circuit, and FPGA for Field-Programmable Gate Array.

The functions of the disclosed feature generation unit 110, email feature generation unit 120, and assessment unit 130 may be implemented by one electronic circuit, or may be distributed among and implemented by a plurality of electronic circuits.

In a different modification, some of the functions of the disclosed feature generation unit 110, email feature generation unit 120, and assessment unit 130 may be implemented by an electronic circuit, and the remaining functions may be implemented by software.

A processor and an electronic circuit are called processing circuitry as well. That is, in the security assessment device 100, the functions of the disclosed feature generation unit 110, email feature generation unit 120, and assessment unit 130 are implemented by processing circuitry.

### Description on Effect of Present Embodiment

The security assessment device 100 according to the present embodiment calculates a similarity degree between a feature of an assessment target email contained in an email box of an assessment target and a feature of information obtained from disclosed information and related to the assessment target. The security assessment device 100 according the present embodiment can quantify, as the similarity degree, how much seemingly authentic a targeted attack email that an attacker can easily generate to an assessment target person is. Thus, with the security assessment device 100 according to the present embodiment, a personal security risk can be calculated quantitatively and automatically by defining this similarity degree as the security risk.

### Embodiment 2

In the present embodiment, a difference from Embodiment 1 will mainly be described. The same configuration as that in Embodiment 1 will be denoted by the same reference sign, and its description will sometimes be omitted.

In Embodiment 1, whether a seemingly authentic targeted attack email can be generated easily is judged by only checking the similarity degree of the trend of words. However, word order patterns exist in an email. In view of this, in a security assessment device 100a according to the present embodiment, a template for a targeted attack email is prepared. Information obtained by OSINT about an assessment target person is applied to the template, thereby generating a template email. Then, the security assessment device 100a calculates a similarity degree between the template email and an assessment target email in an email box of the assessment target. Using the similarity degree, the security assessment device 100a judges how easily a seemingly authentic targeted attack email can be generated.

***Description of Configuration***

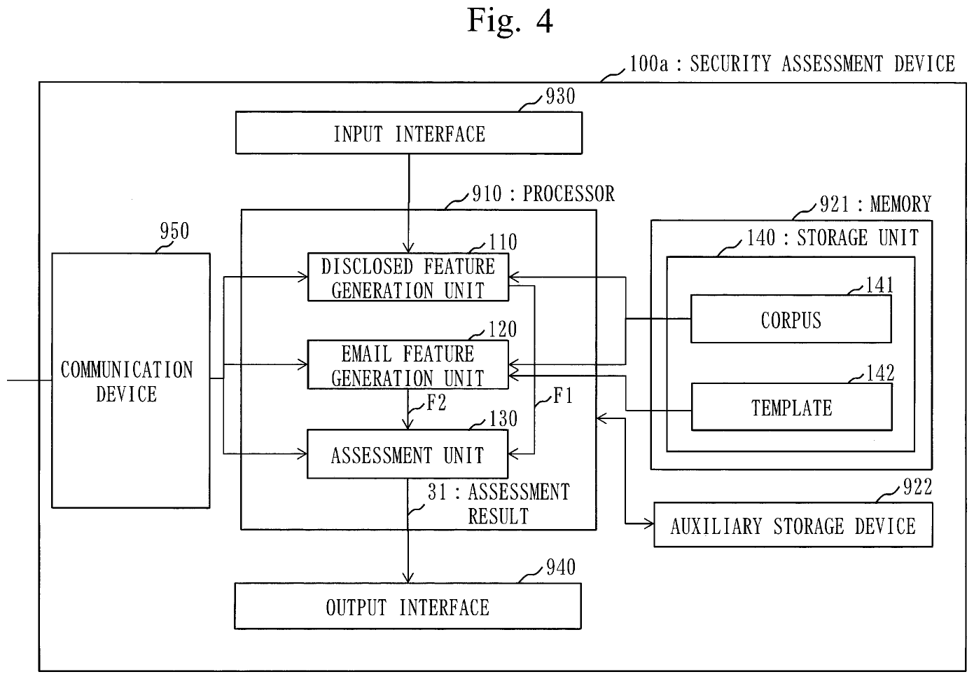

A configuration of the security assessment device 100a according to the present embodiment will be described with referring to FIG. 4.

The security assessment device 100a according to the present embodiment is provided with a template 142 in its storage unit 140, in addition to the configuration of the security assessment device 100 described in Embodiment 1. The template 142 expresses a format of an email.

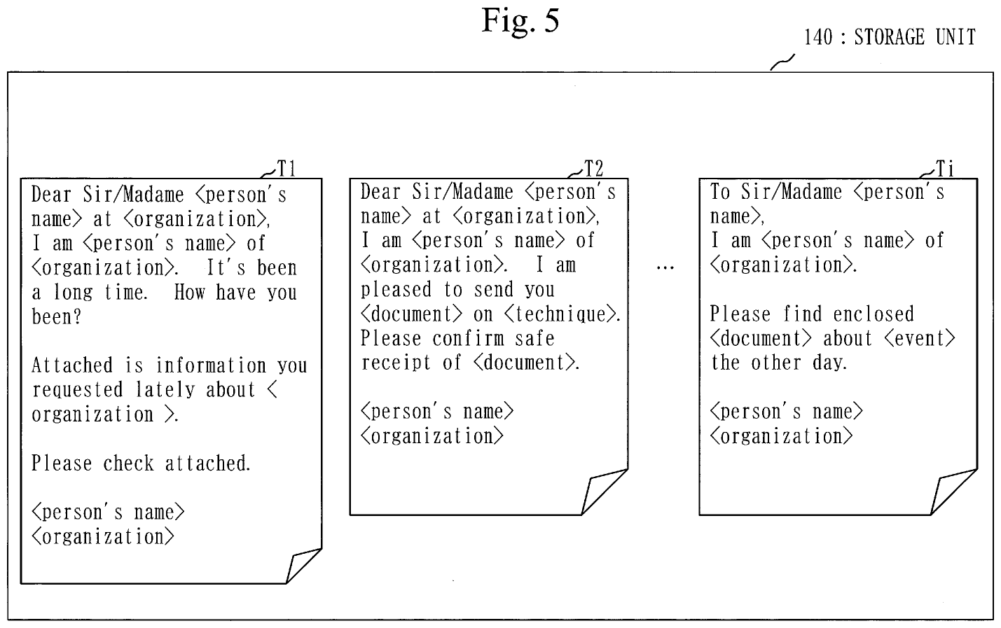

FIG. 5 is a diagram illustrating an example of the template 142 according to the present embodiment.

In FIG. 5, three templates 142 are stored in the storage unit 140. Each template 142 is prepared in advance with referring to a case of a disclosed targeted attack email and so on. Each template 142 is an email with several portions where variables corresponding to categories are set. The variables corresponding to the categories are specifically formats such as <organization>, <person's name>, <technique>, <document>, and <event> which are set in the emails.

***Description of Operations***

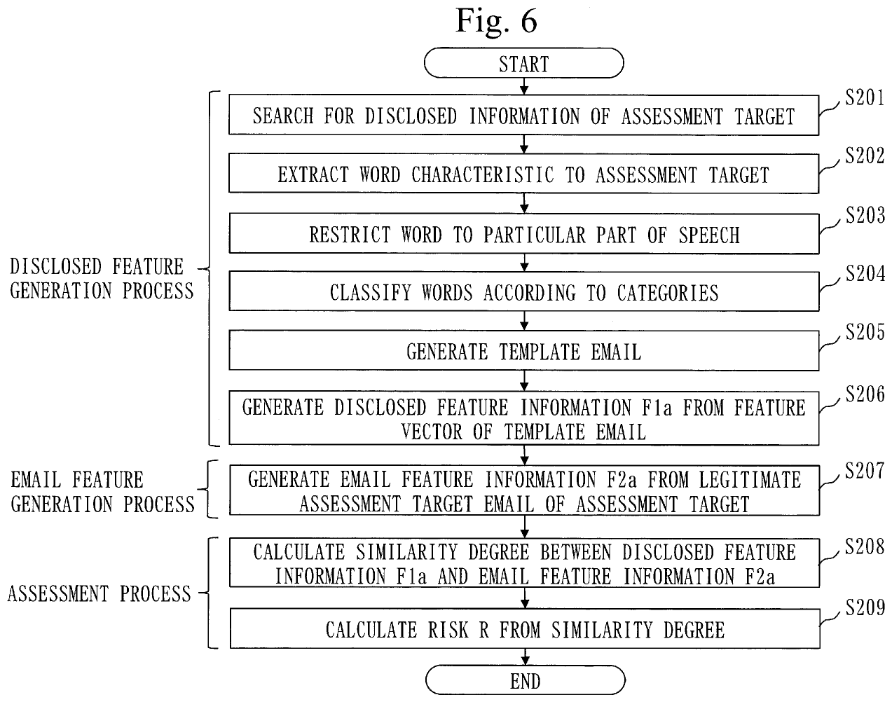

Operations of the security assessment device 100a according to the present embodiment will be described with referring to FIG. 6.

<Disclosed Feature Generation Process: Step S201 to Step S206>

In a disclosed feature generation process, a disclosed feature generation unit 110 collects a word related to an assessment target, as disclosure target information from disclosed information. Then, the disclosed feature generation unit 110 applies the word contained in the disclosure target information to the template, thereby generating a template email. The disclosed feature generation unit 110 generates a feature of the template email, as disclosed feature information Fla. Specifically, this is as follows.

In step S201, the disclosed feature generation unit 110 searches for information related to a person x who is an assessment target, from the disclosed information. In step S202, the disclosed feature generation unit 110 collects a word related to the assessment target, as disclosure target information from the disclosed information. In step S203, the disclosed feature generation unit 110 extracts only a word belonging to a particular part of speech, for example, a noun. Processing of step S201 to step S203 is the same as processing of step S101 and step S102 in Embodiment 1.

In step S204, the disclosed feature generation unit 110 classifies words contained in the disclosure target information according to the categories utilizing a word dictionary such as a thesaurus.

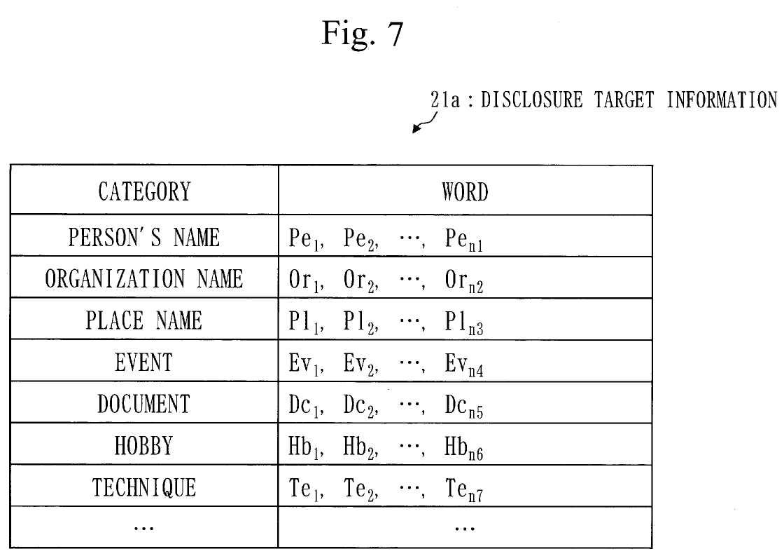

FIG. 7 illustrates an example of disclosure target information 21a according to the present embodiment, which is classified according to categories.

For example, when classifying nouns, the words are classified into categories such as person's name, organization name, place name, event, document, hobby, and technique. To categorically classify the nouns, a word dictionary such as a public thesaurus is utilized. Pe, Or, Pl, Ev, Dc, Hb, and Te in the table of FIG. 7 are practically defined to correspond to specific words. The types of categories are changed as necessary.

In step S205, the disclosed feature generation unit 110 applies the words contained in the disclosure target information 21a to the templates 142, thereby generating a plurality of template emails 42a.

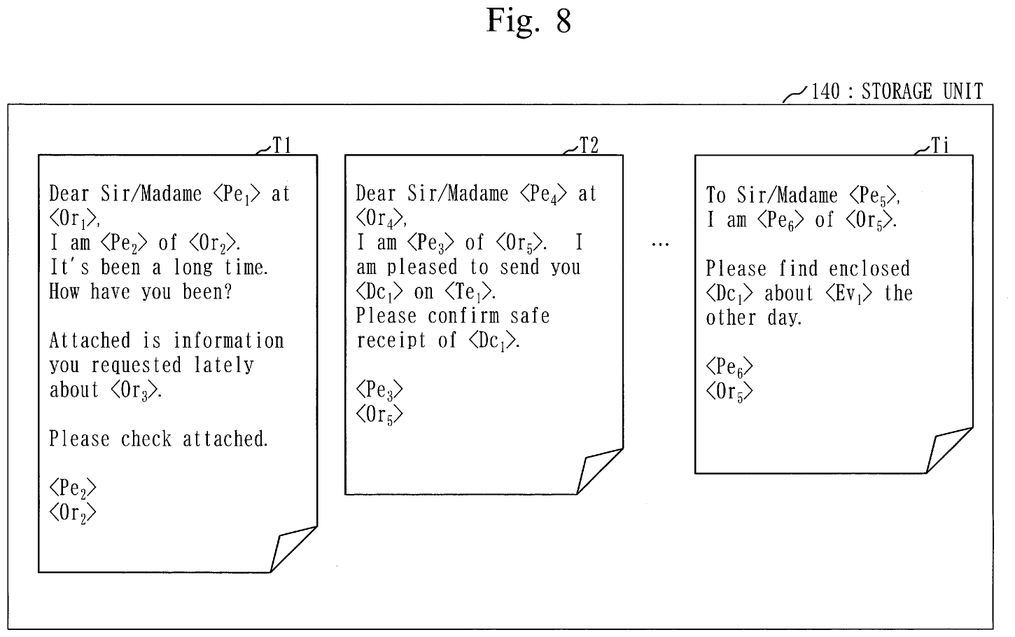

FIG. 8 illustrates examples of the template emails 42a according to the present embodiment.

The disclosed feature generation unit 110 specifically generates, for each template 142, as many template emails 42a as all combinations of words of the corresponding category. The template emails 42a will be referred to as GM_{1,1}, GM_{1,2}, . . . , GM_{1,N1}, . . . , GM_{2,1}, GM_{2,2}, . . . , GM_{2,N2}, . . . , GM_{T,1}, GM_{T,2}, . . . , GM_{T,NT} where T is a number of templates and Nᵢ to N_{T} are each a total number of emails generated for each template.

In step S206, the disclosed feature generation unit 110 generates a plurality of disclosed feature vectors representing individual features of the plurality of template emails 42a, as the disclosed feature information Fla. Specifically, the disclosed feature generation unit 110 extracts feature vectors, as disclosed feature vectors from the templates GM_{1,1}, GM_{1,2}, . . . , GM_{1,N1}, . . . , GM_{2,1}, GM_{2,2}, . . . , GM_{2,N2}, . . . , GM_{T,1}, GM_{T,2}, . . . , GM_{T,NT}. The disclosed feature generation unit 110 refers to the individual disclosed feature vectors as FGM_{1,1}, FGM_{1,2}, . . . , FGM_{1,N1}, . . . , FGM_{2,1}, FGM_{2,2}, . . . , FGM_{2,N2}, . . . , FGM_{T,1}, FGM_{T,2}, . . . , FGM_{T,NT}. The disclosed feature generation unit 110 generates the disclosed feature vectors utilizing, for example, vector expressions in a Doc2Vec document and a trend of words in a document. The trend of words in a document is, for example, a word frequency or n-gram of words. The disclosed feature generation unit 110 may generate disclosed feature vectors utilizing vector expressions of words in the document, such as an average of Word2Vec.

<Email Feature Generation Process: Step S207>

In an email feature generation process, an email feature generation unit 120 generates a feature of an assessment target email contained in an email box of an assessment target, as email feature information F2a. Specifically, this is as follows.

In step S207, the email feature generation unit 120 generates a plurality of email feature vectors expressing features of the plurality of assessment target emails contained in the email box of the assessment target, as the email feature information F2a.

Note that N is a total number of assessment target emails in the email box of the assessment target. Feature vectors are extracted as email feature vectors from legitimate emails existing in the email box of the person x, that is, from assessment target emails M₁, . . . , M_{N}. The email feature generation unit 120 refers to the individual email feature vectors as FM₁, . . . , FM_{N}. The email feature generation unit 120 generates the email feature vectors utilizing, for example, vector expressions in a Doc2Vec document and a trend of words in a document, just as the disclosed feature generation unit 110 does. The trend of words in a document is, for example, a word frequency or n-gram of words. The email feature generation unit 120 may generate the email feature vectors utilizing vector expressions of words in the document such as an average of Word2Vec.

<Assessment Process: Step S208 and Step S209>

In an assessment process, an assessment unit 130 calculates a risk value R representing a security risk of the assessment target based on a similarity degree between the disclosed feature information Fla and the email feature information F2a. Then, the assessment unit 130 outputs the risk value R as an assessment result 31. Specifically, this is as follows.

In step S208, the assessment unit 130 calculates similarity degrees between the plurality of assessment target emails and the plurality of templates. Specifically, the assessment unit 130 calculates the similarity degrees by comparing one by one the email feature vectors FM₁, . . . , FM_{N} of the assessment target emails with the email feature vectors FGM_{1,1}, FGM_{1,2}, . . . , FGM_{1,N1}, . . . , FGM_{2,1}, FGM_{2,2}, . . . , FGM_{2,N2}, . . . , FGM_{T,1}, FGM_{T,2}, . . . , FGM_{T,NT} of the template emails 42a. The assessment unit 130 calculates the similarity degrees using a criterion such as a cosine similarity degree and the Euclidian distance between vectors.

In step S209, the assessment unit 130 calculates the risk value R based on a number of combinations of the assessment target emails and template emails, similarity degrees between the assessment target emails and template emails being equal to the threshold or more. Specifically, the assessment unit 130 calculates the risk value R representing the security risk, using formulae indicated in following Expression 1.

$$R = \frac{1}{T} {\sum }_{i = 1}^{T} {β}_{i} \\ {β}_{i} = \frac{1}{{N}_{i}} {\sum }_{j = 1}^{{N}_{i}} {α}_{i , j} \\ {α}_{i , j} = \frac{{m}_{i , j}}{N} \qquad [ Expression 1 ]$$

In calculation formulae indicated in Expression 1, m_{i,j} is the number of legitimate assessment target emails whose similarity degrees with respect to a jth email generated from an ith template Tᵢ is equal to the threshold or more. Note that N is a total number of emails in the email box, and that Nᵢ is a number of emails generated from the template Tᵢ.

### Description on Effect of Embodiment

The security assessment device 100a according to the present embodiment can quantify, more accurately, how much seemingly authentic a targeted attack email that an attacker can easily generate is. Also, with the security assessment device 100a according to the present embodiment, a personal security risk can be calculated by defining the risk value R as the security mask.

### Embodiment 3

In the present embodiment, differences from Embodiments 1 and 2 will mainly be described. The same configurations as those in Embodiments 1 and 2 will be denoted by the same reference signs, and their description will sometimes be omitted.

Embodiments 1 and 2 describe techniques of assessing a security risk of a particular person. The present embodiment will describe a technique of identifying a person having a low security in an organization, that is, a vulnerable person, while utilizing one or the other of Embodiments 1 and 2.

***Description of Configurations***

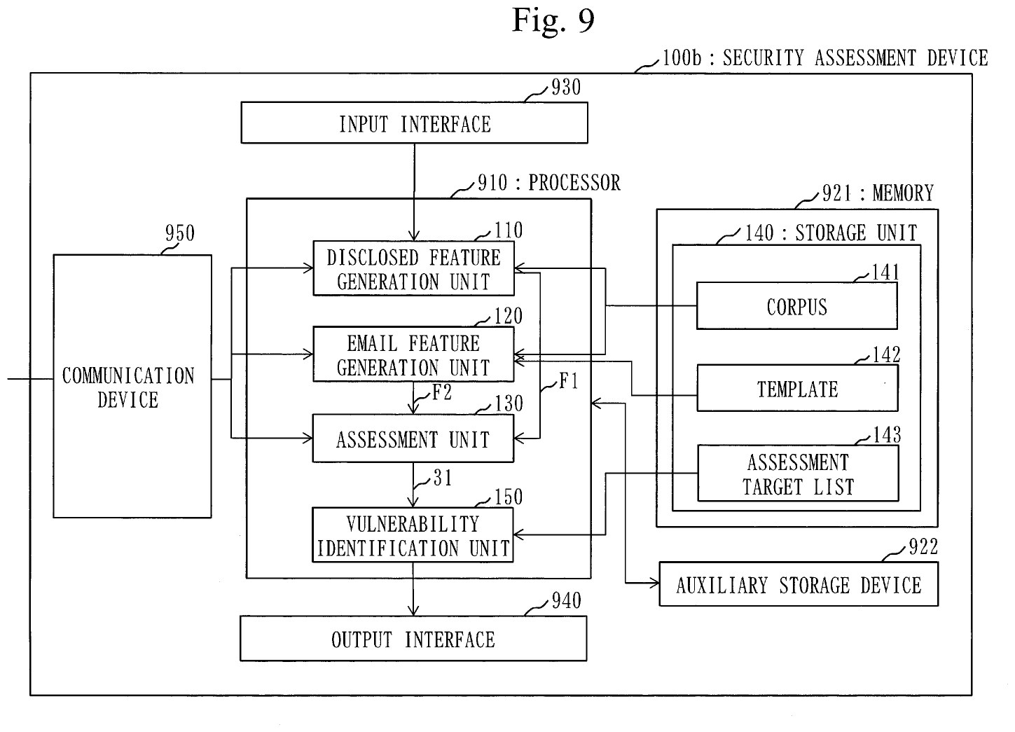

A configuration of a security assessment device 100b according to the present embodiment will be described with referring to FIG. 9.

The security assessment device 100b according to the present embodiment is provided with an assessment target list 143 which lists a plurality of assessment targets, in a storage unit 140. The security assessment device 100b according to the present embodiment is also provided with a vulnerability identification unit 150 which identifies a vulnerable assessment target among the plurality of assessment targets based on individual assessment results 31 of the plurality of assessment targets.

The assessment target list 143 is formed of directory information such as an address book. The directory information includes information such as a person's name and a contact address, and information about the contact address such as information of an affiliation and a job title.

***Description of Operations***

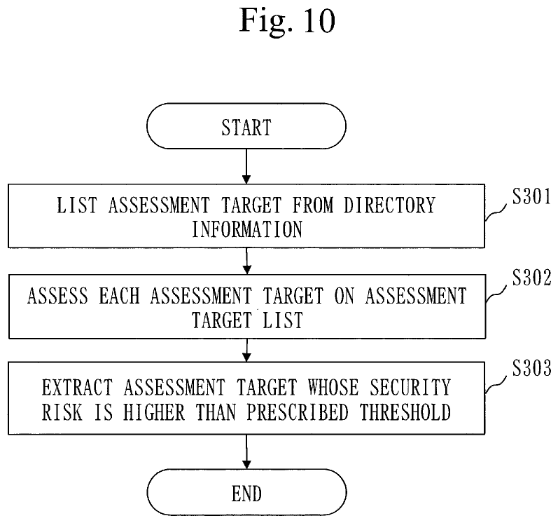

Operations of the vulnerability identification unit 150 of the security assessment device 100b according to the present embodiment will be described with referring to FIG. 10.

Processing other than processing of the vulnerability identification unit 150 is the same as its counterpart processing in Embodiment 1 or 2.

In step S301, the vulnerability identification unit 150 extracts a person whose security risk is to be assessed, as the assessment target list 143 from the directory information. For example, the assessment target list 143 is a list of persons extracted per unit such as a company as a whole, a department, and a section.

In step S302, the vulnerability identification unit 150 picks up persons' names one by one from the assessment target list 143 and assesses their security risks by a method of one or the other of Embodiments 1 and 2. With the method of Embodiment 1, whether there is a security risk or not is obtained as the assessment result 31 for each assessment target. With the method of Embodiment 2, a risk value is obtained as the assessment result 31 for each assessment target. At this time, the information from the directory information such as the name, affiliation, and job title may be utilized. The vulnerability identification unit 150 obtains the assessment result 31 for every assessment target on the assessment target list 143.

In step S303, the vulnerability identification unit 150 lists assessment targets that exceed the prescribed threshold. When assessment is done with the method of Embodiment 1, persons having security risks is listed. When assessment is done with the method of Embodiment 2, persons having risk values equal to the threshold or more are listed. In this manner, a catalogue of persons having high security risks is generated in the assessment target list 143. Hence, the security risks of these persons can be decreased effectively by conducting appropriate education or taking a security countermeasure on these persons.

### Description on Effect According to Present Embodiment

The security assessment device 100b according to the present embodiment can efficiently identify a person having a high security risk in an organization, that is, a vulnerable person. Thus, with the security assessment device 100b according to the present embodiment, the security risk of the entire organization can be decreased by conducting appropriate education or taking a security countermeasure on the listed persons having high security risks.

In above Embodiments 1 to 3, individual units of the security assessment device have been described as independent function blocks. However, the configuration of the security assessment device need not be limited to a configuration as in the embodiments described above. Each function block of the security assessment device may have any configuration as far as it can implement the function described in the above embodiments. Also, the security assessment device is not limitedly formed of one device but may be a system formed of a plurality of devices.

Of Embodiments 1 to 3, a plurality of portions may be practiced by combination. Alternatively, of these embodiments, only one portion may be practiced. In addition, these embodiments may be practiced, whether as a whole or partly, by any combination.

That is, of Embodiments 1 to 3, any embodiments can be combined arbitrarily, any constituent element of each embodiment may be deformed, or any constituent element of each embodiment can be omitted.

The embodiments described above are essentially preferred exemplifications and are not intended to limit the scope of the present invention, the scope of an applied product of the present invention, and a scope of use of the present invention. Various changes can be made in the embodiments described above, as necessary.

### REFERENCE SIGNS LIST

100, 100a, 100b: security assessment device; 110: disclosed feature generation unit; 21a: disclosure target information; 120: email feature generation unit; 130: assessment unit; 31: assessment result; 140: storage unit; 141: corpus; 142: template; 42a: template email; 143: assessment target list; 150: vulnerability identification unit; 909: electronic circuit; 910: processor; 921: memory; 922: auxiliary storage device; 930: input interface; 940: output interface; 950: communication device; R: risk value; F1, F1a: disclosed feature information; F2, F2a: email feature information.

1. A security assessment device comprising:
processing circuitry
to collect information related to an assessment target whose security risk is to be assessed, as disclosure target information from disclosed information that has been disclosed, and to generate disclosed feature information expressing a feature of the disclosure target information,
to generate email feature information expressing a feature of an assessment target email contained in an email box of the assessment target, and
to calculate a similarity degree between the disclosed feature information and the email feature information and to output an assessment result being a result of assessment on the security risk of the assessment target, based on the similarity degree.

2. The security assessment device according to claim 1, wherein the processing circuitry
collects a word related to the assessment target, as the disclosure target information from the disclosed information, and generates the disclosed feature information, based on a trend of words contained in the disclosure target information,
collects a word related to the assessment target, as email word information from the assessment target email contained in the email box of the assessment target, and generates the email feature information based on a trend of words contained in the email word information, and
judges whether or not there is a security risk about the assessment target based on the similarity degree, and outputs a judgment result as the assessment result.

3. The security assessment device according to claim 1,
wherein the security assessment device comprises a template expressing a format of an email, and
wherein the processing circuitry
collects a word related to the assessment target, as the disclosure target information from the disclosed information, applies the word contained in the disclosure target information to the template, thereby generating a template email, and generates a feature of the template email, as the disclosed feature information,
generates the feature of the assessment target email contained in the email box of the assessment target, as the email feature information, and
calculates a risk value representing the security risk of the assessment target based on the similarity degree, and outputs the risk value as the assessment result.

4. The security assessment device according to claim 3,
wherein the processing circuitry
applies the word contained in the disclosure target information to the template, thereby generating a plurality of template emails, and generates a plurality of disclosed feature vectors expressing features of the plurality of template emails, as the disclosed feature information,
generates a plurality of email feature vectors expressing features of a plurality of assessment target emails contained in the email box of the assessment target, as the email feature information, and
calculates similarity degrees between the plurality of assessment target emails and the plurality of template emails, and calculates the risk value based on a number of combinations of the plurality of assessment target emails and the plurality of template emails, similarity degrees between the plurality of assessment target emails and the plurality of template emails being equal to the threshold or more.

5. The security assessment device according to claim 1, comprising:
an assessment target list which lists a plurality of assessment targets, wherein
the processing circuitry identifies a vulnerable assessment target among the plurality of assessment targets based on individual assessment results of the plurality of assessment targets.

6. The security assessment device according to claim 2, comprising:
an assessment target list which lists a plurality of assessment targets, wherein
the processing circuitry identifies a vulnerable assessment target among the plurality of assessment targets based on individual assessment results of the plurality of assessment targets.

7. The security assessment device according to claim 3, comprising:
an assessment target list which lists a plurality of assessment targets, wherein
the processing circuitry identifies a vulnerable assessment target among the plurality of assessment targets based on individual assessment results of the plurality of assessment targets.

8. The security assessment device according to claim 4, comprising:
an assessment target list which lists a plurality of assessment targets, wherein
the processing circuitry identifies a vulnerable assessment target among the plurality of assessment targets based on individual assessment results of the plurality of assessment targets.

9. A security assessment method comprising:
collecting information related to an assessment target whose security risk is to be assessed, as disclosure target information from disclosed information that has been disclosed, and generating disclosed feature information expressing a feature of the disclosure target information;
generating email feature information expressing a feature of an assessment target email contained in an email box of the assessment target; and
calculating a similarity degree between the disclosed feature information and the email feature information and outputting an assessment result being a result of assessment on the security risk of the assessment target, based on the similarity degree.

10. A non-transitory computer readable medium recorded with a security assessment program which causes a security assessment device, being a computer, to execute:
a disclosed feature generation process of collecting information related to an assessment target whose security risk is to be assessed, as disclosure target information from disclosed information that has been disclosed, and generating disclosed feature information expressing a feature of the disclosure target information;
an email feature generation process of generating email feature information expressing a feature of an assessment target email contained in an email box of the assessment target; and
an assessment process of calculating a similarity degree between the disclosed feature information and the email feature information and outputting an assessment result being a result of assessment on the security risk of the assessment target, based on the similarity degree.
